(19) United States
(12) Patent Application Publication
(10) Pub. No.: US 2006/0014880 A1
(43) Pub. Date: Jan. 19, 2006

(54) Nano-talc polymer composites

(76) Inventors: Qiping Zhong, Cupertino, CA (US); Mei Li, Mars, PA (US); Ramanujan Srinivasa, Monroeville, PA (US); Jianhong He, Towanda, PA (US)

Correspondence Address: PAUL J. SHANNAN, NANOMAT INC., 1061 MAIN STREET, NORTH HUNTINGDON, PA, 15642, US

(21) Appl. No.: 11/105,341

(22) Filed: Apr. 11, 2005

Related U.S. Application Data
(63) Continuation-in-part of application No. 10/890,852, filed on Jul. 14, 2004.
(60) Provisional application No. 60/606,294, filed on Sep. 1, 2004.

(51) Int. Cl. C08K 3/34

(52) U.S. Cl. 524/451

(57) ABSTRACT

The invention describes a novel polymer composite comprising nano-talc characterized by an isoelectric point of about 2.5 to about 3.5, a specific surface area greater than about 70 m²/g, and surface hydroxy groups with corresponding hydroxy equivalent weight of about 210 to about 560; and a polymer phase. Specific composites include polyurethane composites prepared from aqueous nano-talc slurries and aqueous dispersible isocyanate terminated polyurethane prepolymers. The invention further embodies a polyurethane composite composition that is a primer coat, base coat or clear top coat for automobiles and metal articles.

### CROSS REFERENCE TO RELATED APPLICATION

This is a non-provisional application claiming priority benefit of provisional application No. 60/606294, filed Sep. 1, 2004, entitled, “Nano-Talc Polymer Composites.” This application is a continuation-in-part of application Ser. No. 10/890,852, filed Jul. 14, 2004 and currently pending, which is incorporated herein by reference.

This invention was made with United States Government support under Agreement No. W911NF-04-2-0025 awarded by U.S. Army. The United States Government has certain rights in the invention.

### BACKGROUND OF INVENTION

1. Field of Invention

The invention relates generally to the field of polymer composites, and specifically to polyurethane composite compositions comprising a novel reactive nano-talc wherein the reactive nano-talc is covalently bonded to a polymer matrix.

2. Description of Related Art

Talc is a naturally occurring mineral, a layered hydrous magnesium silicate of general empirical formula Mg₃Si₄O₁₀(OH)₂, that is broken up and usually ground to a fine powder. Talc is a white, apple green, gray powder with luster pearly or greasy with a Mohs hardness of 1-1.5. It has a high resistance to acids, alkalies and heat. The hydroxy groups normally are internal to the magnesium layer and are not accessible to water except at the edges of the silicate sheet. Thus, conventional talc powder is a hydrophobic material that easily blends and disperses with organic media including polymers but is not easily dispersed in aqueous solvents.

Talc has been used for decades as a non-reactive filler and/or extender for a wide variety of organic polymer composites, paints, coatings, sealants, pigments, and foams, and inorganic composites, ceramic coatings, sealants, foams, and composite structures such as fiberboard and ceiling board. Talc's hydrophobic property makes it easily dispersible in organic polymers and together with low hardness, lubricating properties, barrier properties and low price makes it useful for many filler applications. However, one drawback to talc in its conventional form is that it does not typically covalently bond to polymer matrices.

U.S. Pat. No. 6,458,880 entitled “Polyurethane with Talc Crystallization Promoter” describes a polyurethane composition comprising a polyester-based polyurethane and 0.2 to about 4 wt % conventional talc based on the total weight of the polyurethane composition wherein the polyurethane composition has a crystallization temperature that is at least 10° C. higher than that of the same polyurethane without the talc. U.S. Pat. No. 6,630,534 entitled “Polyurethane Paste Composition and Sealing Material” describes a polyurethane paste comprising a polyurethane resin particles, a plasticizer and fillers, including talc, that when heated forms a hardened product. U.S. Pat. No. 6,737,458 entitled “Silicone Compositions Having Improved Heat Stability” describes a cross-linkable silicone elastomer having from 1 to about 80 wt % of a non-reinforcing filler, including talc. U.S. Pat. No. 6,242,519 entitled “Polyester Molding Composition” describes a thermoplastic glass filled polyester resin composition having improved heat distortion properties that comprises an effective amount of talc as a heat distortion enhancing agent.

In a pending U.S. application Ser. No. 10/890,852 entitled “Methods of Providing Nano-Talc Powders” having the same assignee as the application described herein, a novel hydrophilic nano-talc powder and aqueous nano-talc slurry are described. The nano-talc powder is characterized by a specific surface area (SSA) of about 70 m²/g to about 500 m²/g and further characterized by absorbing about 5 to about 15 wt % water at about 40% to about 60% relative humidity. The characteristics of the hydrophilic nano-talc suggest that there may be a significant excess of hydroxy groups bound to the surface of the nano-talc particles relative to conventional talc. These hydroxy groups may be useful in the development of a wide variety of polymer composites, coatings, sealants, paints, rigid and flexible foams, wherein reactive nano-talc becomes covalently bonded to a polymer matrix. Using the hydroxy group reactivity a wide variety of surface modifications also may be envisioned that allows the nano-talc to covalently bond to polymers. More specifically, we describe herein new curable polyurethane composite compositions comprising aqueous dispersible polyurethane prepolymers and hydrophilic nano-talc particles.

### SUMMARY OF INVENTION

In one embodiment the invention is a polymer composite composition comprising the cured reaction product of: (A) a nano-talc component having a plurality of nano-talc particles characterized by a specific surface area of greater than about 70 m²/g, and hydroxy groups with corresponding hydroxy equivalent weight of about 210 to about 560; and, (B) a polymer, polymer precursor, or mixture thereof. Preferably, said polymer, polymer precursor, or mixture thereof, is capable of covalent bonding with said hydroxy groups.

Another embodiment of the invention is a curable polyurethane composite composition comprising (A) a nano-talc slurry having a plurality of nano-talc particles characterized by a specific surface area of greater than 70 m²/g, and a hydroxy equivalent weight of about 210 to about 560; (B) an aqueous dispersible isocyanate terminated polyurethane prepolymer; and, optionally, (C) a polyol with a number average molecular weight of 100 to 10,000; whereby upon coating and drying and, optionally, heating, the composition is cured to form a hardened coating.

### BRIEF DESCRIPTION OF THE FIGURES

FIG. 1 illustrates the surface area of talc as a function of milling time for conventional one step process of dry milling or wet milling that acts as a control.

FIG. 2 compares the conventional dry and wet-milling processes with the novel hybrid process wherein the talc is first dry milled for 1 hour.

FIG. 3 compares the conventional dry and wet-milling processes with a hybrid process wherein the talc is first dry milled for 2 hours.

FIG. 4 compares the conventional dry and wet-milling processes with a hybrid process wherein the talc is first dry milled for 3 hours.

FIG. 5 shows a TEM image of the hybrid milled talc powder at 10,000× magnification.

FIG. 6 illustrates the surface area of talc as a function of salt milling time.

FIG. 7 compares the moisture uptake of conventional talc and the hydrophilic talc derived from hybrid milling.

FIG. 8 illustrates the isoelectric point plot for hybrid milled nano-talc.

FIG. 9 compares the TGA of hybrid milled talc (lower curve) with conventional talc (upper curve).

### DETAILED DESCRIPTION OF INVENTION

The nano-talc component useful in the invention is derived from novel milling methods referred to as the hybrid milling process described in U.S. patent application Ser. No. 10/890,852 filed Jul. 14, 2004, and the salt milling process, also referred to as matrix separation process described in application Ser. No. 10/175,976, filed Jun. 20, 2002, both commonly owned by the assignee of the application described herein. The nano-talc slurry derived from hybrid milling is preferred for the invention. The milling methods and resulting nano-talc slurries provided will be first described.

The talc powder used in the novel milling processes may be any commercial talc derived from natural sources. The talc initial particle size is not of great importance, but preferably the initial median particle size is about 0.5 μm to about 10 μm and the talc has a specific surface area (SSA) of about 5 m²/g to about 20 m²/g. Commercial samples of such a talc powder are the Luzenac America's NICRON® 674 (SSA 14 m²/g), CIMPACT® 710 (SSA 14 m²/g) and Specialty Minerals Inc. UltraTalc™ 609 (SSA 17 m²/g).

Throughout the specification reference is made to the specific surface area (SSA) of the talc slurry. The SSA number corresponds to that derived from the BET surface area measurement that is described in J. Am. Chem. Soc., 60, 309 (1938) by Brunauer, Emmett and Teller. There are well known commercial instruments available that are used to measure the SSA using nitrogen as the gas absorbed. The SSA is used to monitor the progress of the dry milling, wet milling, and salt milling of the talc powder.

Mechanical milling may be accomplished with any mill that provides high intensity, high energy pounding or grinding such as a vibratory mill, planetary mill, uniball mill or high energy ball mill. Alternative equipment e.g. hammer mill, sand milling, jet mill (steam or air), air classified mill (ACM) plus combination of milling and classification equipment may be used to provide a talc powder with a SSA of about 40 m²/g to about 130 m²/g. Preferred mills for the process are Attritor mills that have a plurality of small solid balls as the grinding media, about 0.2 mm to about 10 mm in diameter, and preferably about 3 mm to about 6 mm. The media may be steel or ceramic balls. Preferably the media is selected from the group of carbon steel, stainless steel, tungsten carbide, ceria stabilized zirconia oxide, zirconia silicate, alumina and yttria-stabilized zirconia balls. The ball to powder ratio and the speed of the mill are two important parameters that determine the energy delivered to the powder in the milling process. Preferably about a 10:1 to about 30:1 weight ratio of ball to powder is used and most preferably about a 20:1 ratio is used. The mill is generally run at about 100 to about 500 rpms.

The nano-talc slurries used in the invention require in the first step a mechanical milling of the talc powder in the dry state, that is, without liquid vehicles such as water, liquid nitrogen or organic solvents. In hybrid milling, no other media is used in the initial grinding process. In salt milling, sodium chloride is preferably used in the grinding process but other salts or organic solids may be used. Preferably about 1 to 16 parts of salt is used as a medium in the salt milling process, and more preferably, 4 to about 6 parts of salt are used. The first stage milling is preferably done in air for a period of time necessary to provide a powder with an SSA of about 40 m²/g to about 130 m²/g. This is usually accomplished in about 1 to 12 hours depending upon the SSA of the starting material and the milling conditions such as the energy input (KW/hour per unit material). In the case of salt milling the powder may exhibit an SSA of about 250 m²/g after eight hours grinding.

In the second step of hybrid milling or salt milling the talc material is mixed with water to form an aqueous talc slurry. Any mixing method may be used. Water may be added to the mill and mixed gently to provide a uniform slurry or dry talc may be transferred to a separate mixing apparatus and mixed under a low shear environment to provide a uniform talc slurry. The water may be untreated tap water or de-ionized water, distilled water, softened water, or the like, but de-ionized water is preferred. The water may be at any temperature between freezing and boiling and water between about 10° C. and about 30° C. is preferred. The water may be slightly acidic or slightly basic with no detriment to the product or process. Preferred is water with a pH between about 3 and about 11 and more preferred is a pH of about 4 to about 10, and most preferred is a pH about 5 to about 10.

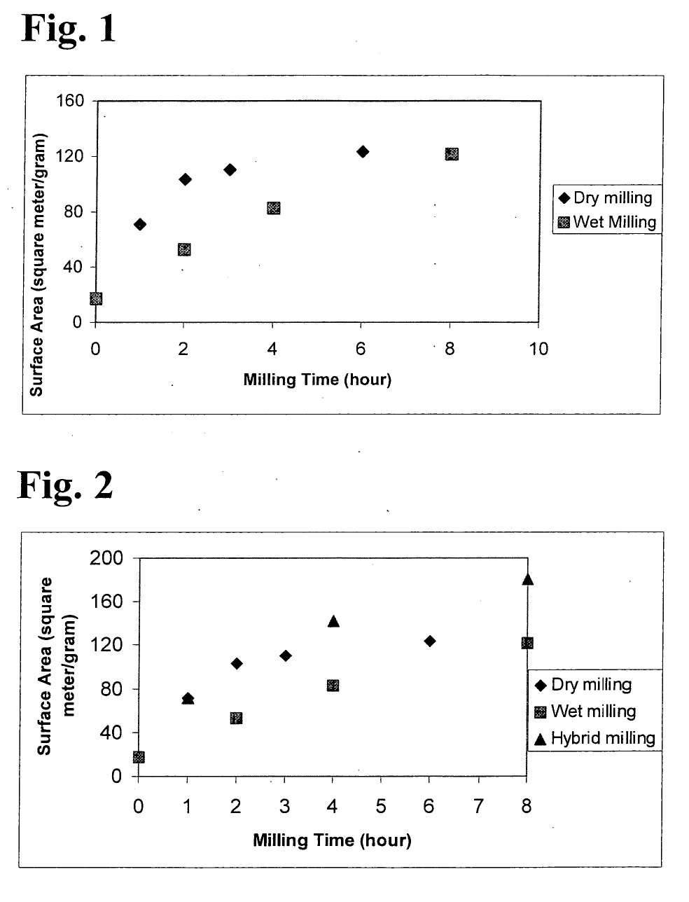

At this point in the processes the hybrid milling, soaking and salt milling processes diverge. In the hybrid milling process in the third step the aqueous talc slurry is wet milled for a period of time to provide an aqueous hydrophilic nano-talc slurry with an SSA between 70 m²/g to about 500 m²/g. The time and temperature of wet milling may vary depending upon the surface area of the talc desired. Preferably, the hydrophilic nano-talc has a SSA of about 120 m²/g to about 400 m²/g and most preferably the hydrophilic nano-talc has a SSA of about 200 m²/g to about 400 m²/g. This method of dry milling followed by wet milling with water is hereafter referred to as the hybrid milling method. The attributes of the hybrid milling method, compared with conventional dry milling or wet milling process are revealed in considering the data displayed in FIG. 1 thru FIG. 4.

FIG. 1 plots the surface area of a talc as a function of milling time for a one step process of dry milling or wet milling that acts as a control. Under dry milling conditions the SSA of talc rises rapidly to a plateau of about 125 m²/g after 6 h. Under wet milling with water the SSA of talc rises gradually and reaches about 125 m²/g after 8 h.

FIG. 2 compares the conventional dry and wet milling process with a hybrid process wherein the talc is dry milled for 1 hour followed by wet milling for 3 and 7 h, respectively. The talc surface reaches 141.5 m²/g and 180.5 m²/g after 3 and 7 h wet milling, respectively.

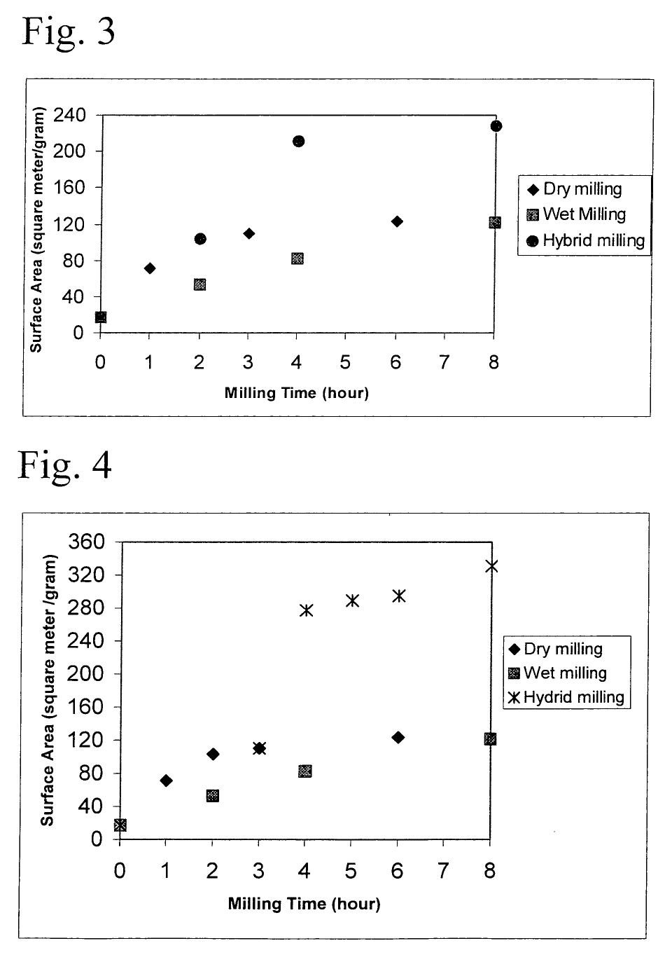

FIG. 3 compares the conventional dry and wet milling process with a hybrid process wherein the talc is dry milled for 2 hours followed by wet milling for 2 and 6 h, respectively. The talc surface reaches 210.6 m²/g and 228.1 m²/g after 2 and 6 h wet milling, respectively.

FIG. 4 compares the conventional dry and wet milling process with a hybrid process wherein the talc is dry milled for 3 hours followed by wet milling for 1, 2, 3 and 5 h, respectively. The talc surface reaches 277.1 m²/g and 331 m²/g after 1 and 5 h wet milling, respectively. From these comparisons it is clear that the hybrid milling leads to significant increases in SSA of the talc slurry.

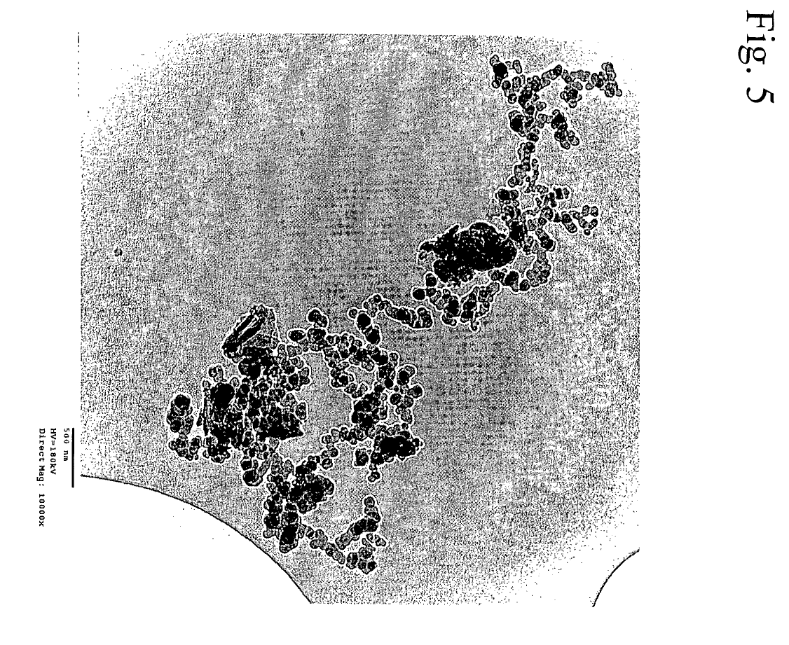

Transmission electron microscope (TEM) images of the powder provided from hybrid milling are shown in FIG. 5. FIG. 5 is an image of the hybrid-milled powder at 10,000× magnification showing the 80 to about 100 nm particles that make up the vast majority of the particles. Further images (not shown) indicate that the 1 μm particles are agglomerates of smaller particles.

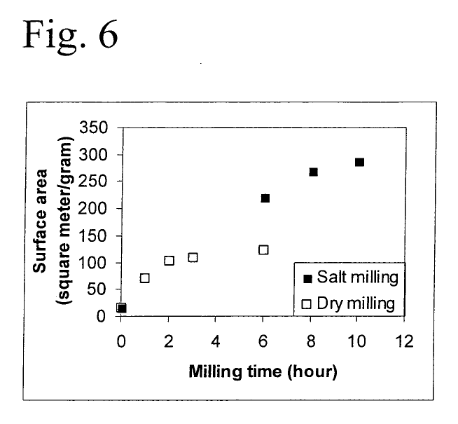

In the salt milling process, after mixing with water the resulting talc slurry is dewatered by a mechanical method. Useful dewatering methods for this step include decantation, membrane filtration and centrifugal decantation. The dewatering allows removal of salt. The talc slurry is further washed and dewatered with water to provide a substantially salt-free talc slurry. The talc slurry derived from salt milling usually is about 5 wt % to about 40 wt % talc. Preferred talc slurry has about 10 to about 20 wt % talc. The attributes of the salt milling method are illustrated in FIG. 6.

There is significant change in the attributes of talc upon treatment with the hybrid milling method. The aqueous talc slurry provided by the hybrid milling process does not settle to give a supernatant liquid, but rather remains a mud-like suspension for months. Gentle stirring results in shear thinning and the suspension breaks into an easily flowable liquid. Talc suspensions derived from the dry milling process, in comparison, settle into a supernatant water layer and a heavier talc fraction within a few minutes. Talc slurry from the salt milling process settles within about 3 days.

The hybrid milling method and salt milling method provide a hydrophilic talc powder. As described earlier, talc is usually considered a hydrophobic mineral that disperses readily in organic solvents or polymers. However, the talc powders derived from hybrid and salt milling disperse only marginally in organic solvents and very readily in water. Conventional dry milling of talc provides a material with the hydrophobic properties of conventional talc.

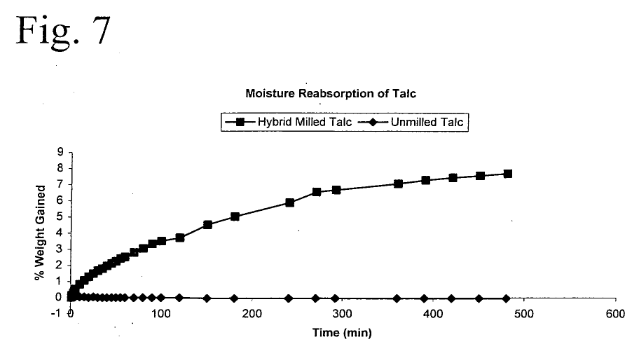

Talc usually has very little moisture associated with it. Dry milling of talc provides a product that has about 0.5 wt % water. The hydrophilic talc derived from the hybrid milling or salt milling method absorbs up to about 5 wt % to about 15 wt % water over a period of twelve hours standing in air. FIG. 7 compares the moisture uptake of conventional talc and the hydrophilic talc provided by the hybrid milling process.

The hydrophilic talc provided by hybrid milling or salt milling is further characterized by remaining suspended over a period of 1 month to about 3 months, when mixed with 2 to 5 parts of water. The hydrophilic talc powder derived from hybrid milling or salt milling may be further characterized by absorbing about 5 wt % to about 15 wt % water at about 40% to about 60% relative humidity.

The hydrophilic talc provided by hybrid milling or salt milling is further characterized by an isoelectric point of 2.5 to about 3.5. The isoelectric point of a particulate material is defined as the pH of the carrier medium at which the zeta potential of the particles is measured to be zero. For measurement of zeta potential, an AC field is applied across an aqueous suspension of the particles, and wavelength change of a laser light beam impinging the aqueous suspension is measured. The solution is then titrated by the addition of base (usually sodium hydroxide solution) or acid (usually hydrochloric acid) to a pre-chosen pH, where the zeta potential is measured. The solution is then titrated in the direction of a target pH, and a zeta potential measured at chosen pH intervals as the titration approaches the second target. The pH where the zeta potential crosses zero, either by direct determination, or by interpolation of successive zeta potential measurements, is considered to be the isoelectric point.

At pH above the isoelectric point the particles are negatively charged. At a pH below the isoelectric point the particles are positively charged. Thus, in unbuffered water the nano-talc slurries derived from hybrid milling or salt milling process comprise negatively charged particles. Using the characteristic negative charge of the nano-talc particles. The nano-talc slurry used in the invention has an isoelectric point preferably about 2.5 to about 3.5 and more preferably about 2.5 to about 3.2. The dry powder derived from the nano-talc slurry preferably has a specific surface area of about 70 to about 500 m²/g and more preferably about 200 to about 400 m²/g. The nano-talc slurries derived from hybrid milling and salt milling are preferred for the invention, and nano-talc from hybrid milling is most preferred.

The hydrophilic talc provided by hybrid milling or salt milling may be further characterized by the presence of surface bound hydroxy groups. Although the inventions disclosed herein are not limited to any mechanism or theory of action, the following explanation is offered as a working model by which the properties of the hydrophilic nano-talc may be understood. Consistent with the proceeding discussion hydrophilic nano-talc may be expected to have a certain amount of moisture associated with the hydrophilic surface, as well as bound hydroxy groups. A differential calorimetry-thermal gravimetric analysis (DSC-TGA) of the nano-talc may be useful in characterization of the amount of moisture bound to the hydrophilic talc and the amount of surface bound hydroxy groups. The latter moisture would be expected to evolve from the talc at a relatively low temperature, for instance, below 120° C. At some higher temperature a pair of surface bound hydroxy groups may react to evolve water and form an anhydride on the talc surface. A measure of the weight lost at some higher temperature range may be related to the surface bound hydroxy groups that may be available for reaction.

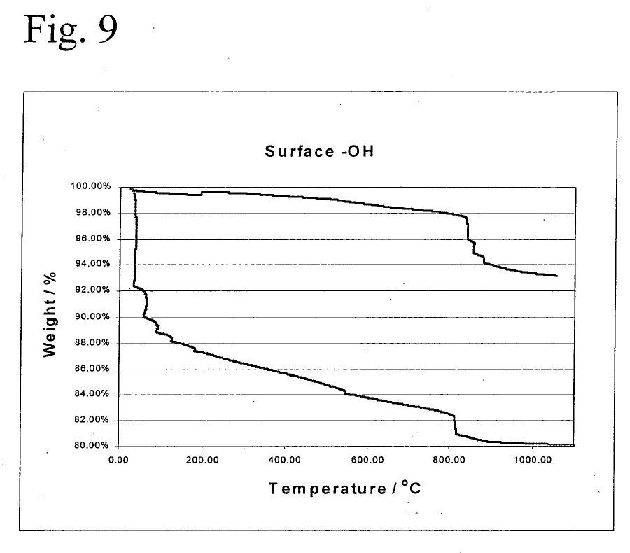

The surface bound hydroxy groups as characterized by TGA analysis as shown in FIG. 9. FIG. 9 upper curve shows the TGA of conventional talc. There is about 0.2 wt % weight loss below 400° C. FIG. 9 lower curve shows the TGA of the nano-talc derived from hybrid milling. There is a 10 wt % to 15 wt % weight loss below 120° C., and about 3.5 wt % loss at about 200 and about 400° C. that is ascribed to bound hydroxy groups. If the high temperature weight loss is due to two metal bound hydroxy groups condensing to form water and a metal oxide bond, then a wt loses of 3.5 wt % is about equivalent to a 7.0 wt % hydroxy group in the nano-talc powder. This corresponds well with what is found in a second independent hydroxy group analysis.

The surface bound hydroxy groups may be further characterized by a hydroxy number as is conventionally done for polyol prepolymers in the field of condensation polymers. Reactive hydroxy groups are acylated with excess acetic anhydride in pyridine. Test results indicate that nano-talc derived from hybrid milling shows about 7.0% hydroxy group by weight compared to about 2.4 wt % hydroxy group for conventional talc. Thus, nano-talc derived from hybrid or salt milling is characterized by a significant excess of hydroxy groups as compared to that of conventional talc. This method also directly measures the presence of reactive hydroxy groups and thus demonstrates that nano-talc derived from hybrid milling or salt milling has the capability to covalently bond to reactive polymers or polymer precursors through the hydroxy functionality.

The nano-talc slurry used in the invention has an isoelectric point preferably about 2.5 to about 3.5. The dry powder derived from the nano-talc slurry preferably has a specific surface area of about 70 to about 500 m²/g and more preferably about 200 to about 400 m²/g. The dry powder also has a hydroxy equivalent weight as measured by DSC-TGA analysis between 200 and 400° C. or analysis with acetic anhydride in pyridine, of about 210 to about 560, and preferably an equivalent weight of about 240 to about 340.

Using the hydroxy group reactivity a variety of surface modifications may be envisioned that allow the nano-talc to covalently bond to polymers to form polymer composites. In the invention, “a polymer, polymer precursor, or mixture thereof, capable of covalent bonding with said reactive surface hydroxy groups” refers to any polymer, prepolymer, monomer or chemical species that, either provides directly, or allows through a sequence of transformations, bonding of nano-talc to polymers.

Monomers and other chemical species include methacrylic and acrylic acid, their chlorides and esters that can form an ester link to nano-talc to provide sites for addition polymerization; 4-vinyl benzyl chloride, bromide and isomers, that can form an ether link to nano-talc to provide sites for addition polymerization; epichlorohydrin that can form an ether link to nano-talc to provide an epoxy site for ring-opening polymerization; bisphenol A diglycidyl ether and other polyfuntional epoxides that can form an ether link to nano-talc and provide sites for further polymerization; bisphenol A bis(chloroformate) and other bis chloroformates that can form an carbonate link to nano-talc and provide sites for polycarbonate polymerization, terephthalic acid, isophthalic acid, adipic acid, and the like, their chlorides and esters that can form an ester link to nano-talc and provide sites for polyester and polyamide polymerization; trialkoxy alkylsilanes that can form a silyloxy link to nano-talc and provide sites, such as vinyl, amino, isocyanato, and methacrylate for polymerization.

Polymers that may be used in such covalent bonding include polyesters, such as poly(ethyleneterephthalate) and poly(ethyleneisophthalate); polycarbonates, such as poly(bisphenol A carbonate) and copolymers thereof; polyamides, such as polyamide 6,6; epoxy thermosets, acrylics, polystyrenes, polyurethanes, polysiloxanes and polyimides.

Nano-talc may be incorporated into polyester and polyamide materials directly in the condensation polymerization processes. For instance, the aqueous nano-talc slurry may be used directly in the interfacial condensation reaction of hexamethylene diamine with adipoyl chloride to provide a nano-talc modified polyamide composite resin. Nano-talc may be used as a slurry or as a dry powder as a source of “polyol” in the polymerization of ethylene glycol with dimethylterephthalate to provide a nano-talc modified polyethyleneterephthalate composite resin. Such resins may have significantly improved barrier properties as compared with the base polymers.

Nano-talc may be modified with epoxy functionality to provide materials useful as reactive cross-linkers for epoxy formulations. The epoxy-modified nano-talc may give improved thermal stability and barrier properties, and electrical properties as compared with the base epoxy resins.

In the present invention, isocyanate terminated polyurethane prepolymer refers to a polyurethane compound, a polyurea compound, a polyisocyanate or mixtures thereof. A polyurethane can be obtained by the reaction of a polyol with a polyisocyanate. A polyurea compound can be obtained by the reaction of an amine with a polyisocyanate. A polyurethane compound or polyurea compound can contain both urea and urethane functionality, depending on what compounds are included in the (A) and/or aside formulations. For the purposes of the present application, no further distinction will be made herein between the polyurethane compounds and polyurea compounds. The term “polyurethane prepolymer” will be used generically to describe a polyurethane compound, a polyurea compound, a polyisocyanate and mixtures thereof.

A polyurethane prepolymer composition useful in the practice of the present invention includes water, and a polymeric compound selected from the group consisting of a polyurethane compound, a mixture of polyurethane-forming compounds, and mixtures thereof.

In the invention, “isoyanate terminated” means that the polyurethane prepolymer has end groups that comprise reactive isocyanate groups and/or protected, or blocked isocyanate groups that upon heating or chemical treatment form reactive isocyanate groups.

The isocyanate terminated polyurethane prepolymers required for the invention may be the commercially available polyisocyanates (a1) or prepolymers can be formed, for instance, by reacting an excess polyisocyanate (a1), a high molecular weight polyol (a2) having a number average molecular weight of 300 to 10,000 and, optionally, a low molecular weight diol (a3), a low molecular weight polyamine (a4), a mono- or di-alkanolamine (a5) or a mixture thereof.

Suitable structural components for polyisocyanates (a1) include any organic compound having at least two free isocyanate groups per molecule. Examples include the diisocyanates X(NCO)₂, whereby X represents a divalent aliphatic hydrocarbon radical with 2 to 12 carbon atoms, a divalent cycloaliphatic hydrocarbon radical with 6 to 15 carbon atoms, a divalent aromatic hydrocarbon radical with 6 to 15 carbon atoms or a divalent arylaliphatic hydrocarbon radical with 7 to 15 carbon atoms. Other examples of compounds that may be used as diisocyanate components are described by W. Siefken in Justus Liebigs Annalen der Chemie, 562, p. 75-136.

Examples of aliphatic diisocyanates with 2 to 20 carbon atoms (excluding those in the diisocyanate) are, e.g., ethylene diisocyanate, tetramethylene diisocyanate, methyl pentamethylene diisocyanate, hexamethylene diisocyanate (hereinafter referred to as HDI), dodecamethylene diisocyanate, and 2,2,4-trimethylhexamethylene diisocyanate.

Examples of alicyclic diisocyanates with 4 to 15 carbon atoms include, e.g., isophorone diisocyanate (hereinafter referred to as IPDI), dicyclohexylmethane-4,4′-diisocyanate (hereinafter referred to as hydrogenated MDI), 1,3- and 1,4-diisocyanatocyclohexane, 1,3- and 1,4-bis(isocyanatomethyl) cyclohexane, methyl cyclohexylene diisocyanate (hereinafter referred to as hydrogenated TDI), and bis(2-isocyanato ethyl)-4-cyclohexene.

Examples of aromatic polyisocyanates with 6 to 14 carbon atoms include, e.g., 1,3- and 1,4-phenylene diisocyanate, 2,4- and 2,6-toluene diisocyanate (hereinafter referred to as TDI), crude TDI, 2,4′- and/or 4,4′-diphenylmethane diisocyanate (hereinafter referred to as MDI), 4,4′-diisocyanato biphenyl, 3,3′-dimethyl-4,4′-diisocyanato biphenyl, 3,3′-dimethyl-4,4′-diisocyanato diphenylmethane, crude MDI, and 1,5-naphthalene diisocyanate. Examples of arylaliphatic isocyanate with 8 to 15 carbon atoms include, e.g., m- and/or p-xylylene diisocyanate (XDI), and tetramethyl xylylene diisocyanate (TMXDI).

Preferable polyisocyanates (a1) for the invention are aliphatic diisocyanates and alicyclic diisocyanates described above and prepolymers derived therefrom. Most preferred polyisocyanates for the invention are hexamethylene diisocyanate, isophorone diisocyanate, methyl cyclohexylene diisocyanate (TDI), and prepolymers derived therefrom.

It is also possible to incorporate higher-functional polyisocyanates or modified polyisocyanates or polyisocyanate adducts, having, for example, carbodiimide groups, allophanate groups, isocyanurate groups, urethane groups and/or biuret groups that are known per se in polyurethane chemistry. A mixture of two or more diisocyanates and/or a mixture of two or more modified polyisocyanates or polyisocyanate adducts may be used in formulation of the isocyanate terminated polyurethane prepolymers.

Suitable structural components for the high molecular weight diol (a2) include organic compounds containing at least two free hydroxyl groups, which are capable of reacting with isocyanate groups. Examples of such organic compounds include higher-molecular compounds from the classes of polyester, polyester amide, polycarbonate, polyacetal and polyether polyols with a number average molecular weight of at least 300, preferably 500 to 8000, and more preferably 800 to 5000 daltons. Preferred compounds are, for example, those containing two hydroxyl groups, such as polyether diols, polyester diols and polycarbonate diols.

Examples of polyester polyols include linear polyester diols or weakly branched polyester polyols, prepared from aliphatic, cycloaliphatic or aromatic dicarboxylic or polycarboxylic acids or anhydrides thereof, such as succinic, glutaric, adipic, pimelic, suberic, azelaic, sebacic, nonane dicarboxylic, decane dicarboxylic, terephthalic, isophthalic, o-phthalic, tetrahydrophthalic, hexahydrophthalic or trimellitic acid, and acid anhydrides, such as o-phthalic, trimellitic or succinic anhydride or a mixture thereof with polyhydric alcohols, such as, e.g., ethanediol, diethylene, triethylene, tetraethylene glycol, 1,2-propanediol, dipropylene, tripropylene, tetrapropylene glycol, 1,3-propanediol, butane-1,4-diol, butane-1,3-diol, butane-2,3-diol, pentane-1,5-diol, hexane-1,6-diol, 2,2-dimethyl-1,3-propanediol, 1,4-dihydroxycyclohexane, 1,4-dimethylol cyclohexane, octane-1,8-diol, decane-1,10-diol, dodecane-1,12-diol or mixtures thereof, optionally with the additional use of higher-functional polyols, such as trimethylol propane or glycerol. Examples of polyhydric alcohols for production of the polyester polyols also include cycloaliphatic and/or aromatic dihydroxyl and polyhydroxyl compounds. Instead of the free polycarboxylic acid the corresponding polycarboxylic anhydrides or corresponding polycarboxylic acid esters of low alcohols or mixtures thereof can also be used to produce the polyesters.

The polyester polyols can also be homopolymers or copolymers of lactones, which are preferably obtained by reacting lactones or lactone mixtures, such as butyrolactone, .ε-caprolactone and/or methyl ε-caprolactone with suitable difunctional and/or higher functional initiator molecules, such as the low-molecular, polyhydric alcohols mentioned above.

Polycarbonates having hydroxyl groups are also suitable as polyhydroxyl components, and include those that can be produced by reacting diols such as 1,4-butanediol and/or 1,6-hexanediol with diaryl carbonates, e.g., diphenyl carbonate, dialkyl carbonate, such as dimethyl carbonate or phosgene, with a number-average molecular weight of 800 to 5000 daltons.

Preferred structural components for (a2) are polyester diols based on adipic acid and glycols such as 1,4-butanediol, 1,6-hexanediol and/or 2,2-dimethyl-1,3-propanediol (neopentyl glycol). Likewise preferred are copolymers of 1,6-hexanediol with ε-caprolactone and diphenyl carbonate with a number-average molecular weight of 1000 to 4000 daltons, and 1,6-hexanediol polycarbonate diols with a number-average molecular weight of 1000 to 3000 daltons.

Other preferred structural components for (a2) are polyester diols based on adipic acid and glycols such as 1,4-butanediol, 1,6-hexanediol and/or 2,2-dimethyl-1,3-propanediol (neopentyl glycol). Likewise preferred are copolymers of 1,6-hexanediol with ε-caprolactone and diphenyl carbonate with a number-average molecular weight of 1000 to 4000 daltons, and 1,6-hexanediol polycarbonate diols with a number-average molecular weight of 1000 to 3000 daltons.

Examples of polyether polyols include the polyaddition products of styrene oxides, of ethylene oxide, propylene oxide, tetrahydrofuran, butylene oxide, epichlorohydrin, and their co-addition and graft products, as well as the polyether polyols obtained by condensation of polyhydric alcohols or mixtures thereof and by alkoxylation of polyhydric alcohols, amines and aminoalcohols.

The structural component polyol, (a2), includes polyether diols initiated on aromatic diols, which are produced, for example, by polyaddition of alkylene oxides, such as propylene oxide, ethylene oxide, butylene oxide or styrene oxide to aromatic diols. Preferred alkylene oxides are propylene oxide and ethylene oxide, propylene oxide is particularly preferred. Examples of suitable aromatic diols include hydroquinone, resorcinol, catechol or 2,2-bis(4-hydroxyphenyl)propane (bisphenol A). Aromatic polycarboxylic acids, such as, e.g., o-, iso- or terephthalic acid can also be used as initiators for the alkoxylation reaction. 2,2-bis(4-hydroxyphenyl)propane is preferred.

Preferred polyether polyols initiated on aromatic diols are the propoxylation products of 2,2-bis(4-hydroxyphenyl)propane (bisphenol A) in the molecular weight range between 300 and 3000 dalton, particularly preferably between 500 and 1250 dalton.

Suitable structural components for low molecular weight diols (a3) include diols in the molecular weight range 62 to 299. They include, for example, the polyhydric, in particular, dihydric, alcohols mentioned for the production of the polyester polyols, as well as low-molecular polyester diols, such as, e.g., adipic acid bis(hydroxyethyl)ester. Preferred structural components (a3) are 1,2-ethanediol, 1,4-butanediol, 1,6-hexanediol and 2,2-dimethyl propane-1,3-diol. 1,4-butanediol and 1,6-hexanediol are more preferred.

The polyurethane composite composition can include a chain extender. A chain extender is used herein to build the molecular weight of the polyurethane prepolymer by reaction of the chain extender with the isocyanate functionality in the polyurethane prepolymer, i.e., chain extend, the polyurethane prepolymer. A suitable chain extender is typically a low equivalent weight active hydrogen containing compound, having about 2 or more active hydrogen groups per molecule. The active hydrogen groups can be hydroxyl, mercaptyl, or amino groups. An amine chain extender can be blocked, encapsulated, or otherwise rendered less reactive. Other materials, particularly water, can function to extend chain length and so are chain extenders for purposes of the present invention. Preferred chain extenders are the low molecular weight polyamines (a4). It is particularly preferred that the chain extender be selected from the group consisting of amine terminated polyethers such as, for example, Jeffamine D400 from Huntsman Chemical Company, amino ethyl piperazine, 2-methyl piperazine, 4,4′-diamino-3,3′-dimethyl dicyclohexylmethane, 1,4-diaminocyclohexane, 1,5-diamino-3-methyl-pentane, isophorone diamine, ethylene diamine, diethylene triamine, triethylene tetramine, triethylene pentamine, ethanol amine, lysine in any of its stereoisomeric forms and salts thereof, hexane diamine, hydrazine piperazine and arylaliphatic diamines such as xylylenediamine and α,α,α′,α′-tetramethylxylylenediamine. Among these compounds preferred are alicyclic diamines and aliphatic diamines, particularly isophoronediamine and hexamethylenediamine. In the practice of the present invention, the chain extender is often used as a solution of chain extender in water.

Suitable mono- or di-alkanolamines (a5) include monoalkanolamines with 2 to 4 carbon atoms such as monoethanolamine, monopropanolamine, and the like; dialkanolamines with 4 to 8 carbon atoms such as diethanolamine, dipropanolamine, and the like; and mixtures of two or more of these compounds. Among these compounds, preferred are dialkanolamines, and particularly diethanolamine and dipropanolamine.

In a typical synthesis of the isocyanate terminated polyurethane prepolymer, the polyol and optionally, low molecular weight diol are heated to remove residual water. Solvent, such as toluene or xylene, may be added in this step to obtain an azeotrope or the dehydration may be done in the absence of solvent. Often the dehydration is done under reduced pressure in the absence of solvent. After dehydration is complete, optionally solvent may be added, followed by addition of the polyisocyanate. The mixture is then stirred and heated, preferably at about 80° C. to about 100° C. until the isocyanate level becomes constant, usually about 4 to 10 hours. Optionally, a low molecular weight polyamine (a4) and/or a mono-or di-alkanolamine (a5) may be added during the heating cycle. Preferably, the amines are added near to the end of the heat cycle. The amine reaction usually results in chain extension of the polyisocyanate by formation of urea links that may be desirable in certain applications.

Suitable solvents for the polyurethane condensation include ethyl acetate, butyl acetate, 1-methoxypropyl-2-acetate, 3-methoxy-n-butyl acetate, acetone, 2-butanone, 4-methyl-2-pentanone, cyclohexanone, toluene, xylene, chlorobenzene, dimethyl carbonate, diethyl carbonate, γ-butyrolactone, ε-caprolactone, diethyl carbonate, diethylene glycol dimethyl ether, dipropylene glycol dimethyl ether, N-methyl pyrrolidone and N-methyl caprolactam or any blends of such solvents. Preferred solvents are ethyl acetate and toluene.

The isocyanate terminated prepolymers can be blocked, if desired, by addition of a monofunctional blocking agent. The phrase “blocked isocyanate group” refers to a functional group that breaks down to form an isocyanate group and a blocking compound. Any blocked isocyanate group known to those skilled in the art may be employed in the present invention. Examples of blocking compounds that may be used to prepare blocked isocyanates include, but are not limited to, phenols; alcohols; alkyl acetoacetates such as methyl acetoacetate; dialkyl malonates such as diethyl malonate; pyrazoles including 3,5-dimethylpyrazole and 3-methylpyrazole; oximes including those prepared from methyl ethyl ketone, acetone, and diisopropyl ketone; and lactams such as ε-caprolactam. Upon heating, blocked isocyanate groups are unblocked to produce reactive isocyanate groups.

The molar ratio of the respective constituent parts making up the isocyanate terminated prepolymer is, for 1 mole of polyisocyanate (a1): polyol (a2) generally may be about 0.4 to about 0.8 mole; low molecular weight diol (a3) may be 0 to 0.2 mole; low molecular weight polyamine (a4) may be 0 to about 0.2 mole and the (a5) may be 0 to about 0.1 mole. The content of free isocyanate group in the polyurethane prepolymer used in the invention is generally 2 to about 20 wt %, and preferably about 5 to 15 wt %.

The aqueous dispersible isocyanate terminated polyurethane prepolymers used in the invention may be available from a variety of pathways generally known in the art. Isocyanate terminated prepolymers may be prepared by conventional methods and dispersed in aqueous solution by using conventional combinations of mixers and dispersing agents. For instance, U.S. Pat. No. 6,630,534, discloses the use of 2 wt % poly(vinyl alcohol) as a dispersing agent for a 30 wt % aqueous polyurethane dispersion.

Hydrophilic polyurethane resins may be specially formulated with hydrophilic groups for rapid dispersal in aqueous solution. For instance, U.S. Pat. No. 6,677,400, entitled “Aqueous Dispersions of Hydrophilic Polyurethanes Resins” herein incorporated by reference, discloses polyurethane resin dispersions that have a content of 3 to 30 mmol of alkali metal salts of sulfonic acids per 100 g polyurethane resin solids. Such ionic groups may be incorporated by the addition of structural components (a6), such as diamines or polyamines containing alkali sulfonate groups, during synthesis of the polyurethane resins. Examples of suitable compounds (a6) are the alkali metal salts of N-(2-aminoethyl)-2-aminoethane sulfonic acid. The sodium salt is preferred. The free sulfonic acids salts may also be incorporated during the isocyanate polyaddition process. The polyurethanes may be dispersed in water, preferably using the so-called acetone process as disclosed in U.S. Pat. No. 3,479,310. In the acetone process the isocyanate terminated prepolymers are dissolved in a water miscible solvent such as acetone to give a wt % solids of about 20 to 80 wt %. Other solvents, such as, e.g., 2-butanone, tetrahydrofuran, dioxane or mixtures of these solvents may also be used. The isocyanate terminated prepolymer is then reacted with mixtures of the amino-functional components (a4), (a5) and (a6) with chain extension to form a higher-molecular weight isocyanate terminated prepolymer. Water is then added and the organic solvent substantially removed by distillation to give the aqueous dispersions to the isocyanate terminated prepolymers.

Stable one-component polyurethane prepolymer dispersions with chemically blocked isocyanates may be formulated by chemical blocking of the isocyanates with monofunctional reaction partners, for instance, as described in EP 159 117. Stable polyurethane prepolymer dispersions of surface-deactivated or encapsulated solid polyisocyanates can be made by treatment of polyisocyanates with suitable deactivating agents as described in U.S. Pat. No. 4,888,124, hereby incorporated by reference. U.S. Pat. No. 6,686,416, hereby incorporated by reference, describes storage stable isocyanate dispersions that may be made based on encapsulated solid isocyanate that has been deactivated with a low molecular deactivating agent such as a primary or secondary amino group.

The curable polyurethane composite composition of the invention may also comprise one or more polymerization catalysts for promoting the reaction of the isocyanate terminated prepolymer with polyfunctional compounds. Specific examples of catalysts are dibutyltin dilaurate, dibutyltin dioleate, dimethyltin dilaurate, dimethyltin distearate, trioctyltin oxide, trioctyltin acetate, bis-trioctyltin phthalate, monobutyltin tris(2-ethylhaxoate), monomethyltin tris(2-ethylhexanoate), zinc octoate, zinc palmitate, zinc oleate, zinc tallate, zinc stearate, bismuth 2-ethylhexanoate, bismuth laurate, bismuth neodecanoate, bismuth oleate, bismuth tallate, and bismuth stearate. Particularly suitable are liquid or solid organotin catalysts such as dibutyltin dilaurate, monobutyltin tris(2-ethyl hexanoate), trioctyltin oxide, and trioctyltin acetate.

A curable polyurethane composite composition of the invention can be prepared by mixing an aqueous nano-talc slurry, derived from hybrid milling or salt milling processes, with aqueous dispersible isocyanate terminated polyurethane prepolymer, and optionally, a polyol. Additional optional components can include diamines, monoamines, hydrophobic amines, catalysts, light and heat stabilizers, anti-foaming agents, viscosity modifiers and other processing aids. Mixing can be accomplished by any conventional method including high speed stirring, sonication, jet-mixing, and nozzle mixing.

The curable compositions can be coated onto a variety of substrates and cured at ambient temperature or elevated temperature to provide the coated composite compositions.

The polymer composite compositions of the invention can be used in a wide variety of products. For instance, polyester composite can be used in molded articles such as plastic bottles and barrier film applications. Polyamide composites can be used in film applications and molding applications. Polycarbonate composites of the invention can be used as molded parts including applications in optically transparent articles such as headlight housings.

Polyurethane and polysiloxane composites can be used in many film, protective barrier coating, sealing and gasketing applications. For instance, the polyurethane composites of the invention are useful as primer coatings, base coatings and clear top coatings for automobile applications, both interior and exterior. Polyurethane composite coatings can also be used as wood coatings for floors, furniture and decks; coatings for concrete floors, walls and masonry; coatings for metal articles including aircraft, ships, boats, recreational vehicles; and structural metal objects such as girders, bridges and decks.

In formulations within the examples, the composite coatings of the invention have low haze values at relatively high loadings of nano-talc. For instance, comparison of haze values in Example 5 and 6 indicate that the nano-talc compositions exhibit much lower haze than conventional talc at the same loading.

### Nano-Talc Preparation 1

The following description illustrates the preparation of a nano-talc slurry by the hydrid milling process and is characterized by an increase in surface area when ground talc is further treated with water in a wet milling process:

UltraTalc™ 609 talc powder (800 g, Specialty Minerals Inc., initial SSA about 17 m²/g, 0.9 um average particle size) and 4.8 mm yttria-stabilized zirconia balls (16 Kg, d=5.75 g/cm³) were loaded into an Union Process 1-S Attritor with stainless steel tank and shaft and mechanically milled (energy input about 0.8 KW/h) with external water cooling for 3 hours at 350 rpm to provide a powder with an SSA of 113.8 m²/g). Untreated tap water (2.5 L) was added to the tank and milling continued for another 3 hours. The slurry was discharged and dried in an oven (100° C., 12 h, in air). The resulting powder has an SSA of 295.1 m²/g. The particle size is an average platelet diameter of about 80 to 100 nm as determined by TEM on a sample dispersed in methanol and deposited on a carbon grid. A 20 cm deep sample of the talc slurry separated into about 1-2 mm water and 19.8-19.9 cm talc suspension over 3 months.

### Nano-Talc Preparation 2

The following illustrates the preparation of nano-talc by the salt milling method. UltraTalc® 609 powder (4 kg, initial SSA about 17 m²/g), sodium chloride (20 kg), and 5 mm yttria stabilized zirconia balls (277.5 kg) were loaded into a 30 S Szegvari Attritor (Union Process Inc.), and mechanically milled 10 hours at 135 rpm. Samples were taken at 6 h and 8 h for SSA measurement. The salt/talc mixture was transferred to a membrane filter press and washed with water until the conductivity measured less than 1 ms/cm to provide a nano-talc cake of about 50 wt % talc. Dried samples at 6, 8 and 10 hours had SSA values of about 220, 270 and 288 m²/g, respectively.

### Nano-Talc Characterization—Moisture Uptake

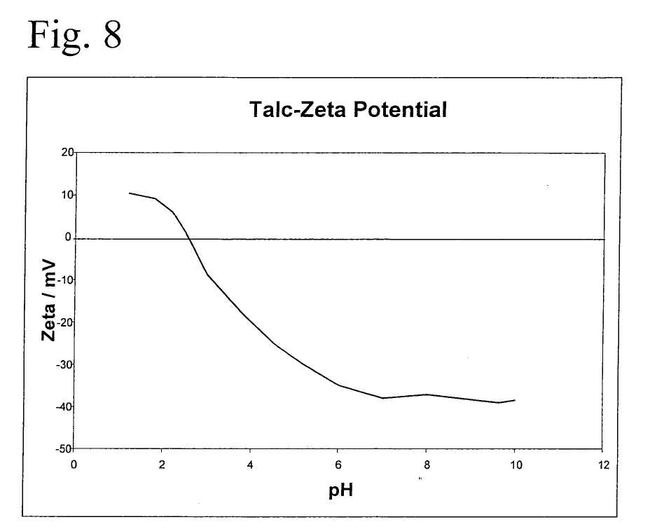

A sample of the hybrid milled talc slurry was dried at 200° C. until no further weight loss was exhibited in a Mettler-Toledo HR83P moisture balance. The resultant material was then ground in a mortar and pestle, and re-dried in the same manner as before. The powder was allowed to cool in a vacuum desiccator, then placed on a tared balance and monitored for moisture weight gain at a relative humidity of about 49%. This was also repeated from the drying steps with unmilled UltraTalc® 609 powder. The weight gain of hybrid-milled and unmilled samples is plotted in FIG. 8 and illustrates the significantly greater moisture absorption of the hybrid-milled nano-talc product.

### Nano-Talc Characterization—Isoelectric Point

The following description illustrates the characterization of nano-talc by isoelectric point determination. A sample of nano-talc suspended in de-ionized water was prepared in a sample cup and diluted to give a Malvern Zetasizer CPS correlator count of 500 to 2000. The suspension was visibly clear, and free of dust particles. The suspension was placed in the auto-titrator unit of the Malvern Zetasizer 3000 HS. The experiment began by a machine check of detector counts. The suspension was titrated to pH of 2, by measured addition of 1.0 M HCl solution. Zeta potential of the talc at this pH was then determined by standard Dynamic Light Scattering (DLS) techniques. The suspension was then titrated stepwise, with a step of about 0.5 pH units, toward a pH of 7. At each step, the Zeta potential of the nano-talc was measured by DLS, and plotted vs. pH of the suspension. The pH at which the Zeta potential interpolated to be 0 was interpreted as the isoelectric point. Four nano-talc samples were measured in this manner.

### Nano-Talc Characterization—Hydroxy Number

To determine the surface hydroxyl content of a hybrid milled talc, SSA: 295 m²/g, ASTM method D4274-99 was chosen. Each test was performed in a 500 mL pressure bottle, and performed in duplicate with a corresponding blank. For each sample, acetic anhydride in pyridine (20 mL, 11 vol %) was placed in a 500 mL pressure bottle and nano-talc (1.0 g) was added and mixed by swirling. The bottles were then capped, and submerged in slowly boiling water for one hour. The bottles were then allowed to cool outside of the water bath, and uncapped. The bottle walls were rinsed with water, and crushed water ice added to the bottle. Phenolphthalein in pyridine solution (1 mL, 1 g per 100 mL) was added and the material titrated with a 0.5N NaOH solution to a persistent pink endpoint. A hydroxyl number, mg OH/g was then calculated by the following formula:
Hydroxyl Number=[(B−A)0.5×17]/W
wherein: B=NaOH required for titration of Blank (mL); A=NaOH required for titration of sample (mL); W=mass of sample used (g).

For the hybrid milled talc, the hydroxyl content was 6.99% by weight as compared to 2.4% for conventional talc.

It is understood that the above-described embodiments of the invention are illustrative only and modification thereof may occur to those skilled in the art. Accordingly, it is desired that this invention is not to be limited to the embodiments disclosed herein but is to be limited only as defined by the appended claims and their legal equivalents.

The following examples are meant to illustrate the invention and are not meant to limit the scope of the invention.

### EXAMPLE 1

Examples 1 and 3 illustrate the reactivity of nano-talc in the polyurethane composites of the invention as compared to similar formulations with conventional talc described in Comparative examples 2 and 4.

A mixture of nano-talc (20 g, 14 wt %, Preparation 1), DI water (16 g), and Bayhydur 302 polyisocyanate (5.2 g, NCO 17.8 wt %, Bayer Material Science) was stirred at RT until homogeneous. The NCO/OH ratio was 2:1 based upon a nano-talc equiv wt of 243. The blend was coated onto a PET substrate with an 8 mil gap and dried at room temperature to give a tack-free translucent film in about 3 h.

### EXAMPLE 2 (COMPARATIVE)

A mixture of Ultratalc 609 (2.6 g), DI water (33.4 g) and Bayhydur 302 (5.2 g) was stirred until homogeneous. The blend was coated onto a PET substrate with an 8 mil gap and cured at RT for 4 days. The material was still wet and uncured after four days.

### EXAMPLE 3

A mixture of nano-talc (20 g, Preparation 1, 13 wt %), DI water (16 g), and Desmodur N 3600 (3.65 g, NCO 23 wt %, Bayer Material Science) was mixed until homogeneous. The NCO/OH ratio was 2:1. The blend was coated onto a PET substrate with an 8 mil gap and cured at RT for 3 h to give a tack-free translucent film.

### EXAMPLE 4 (COMPARATIVE)

A mixture of Ultratalc 609 (2.6 g) DI water (33.4 g) and Desmodur N 3600 (3.65 g) was mixed until homogeneous. The blend was coated onto a PET substrate with an 8 mil gap and cured at RT for 4 days. The material was still wet and uncured after four days.

### EXAMPLE 5

This example illustrates the formation of polymer composites comprising the cured reaction product of nano-talc and an isocyanate terminated polyurethane prepolymer.

A series of loadings of nano-talc aqueous slurry (14% solid, Preparation 1), were prepared comprising hydroxy-terminated polyurethane Bayhydrol® XP7100E (29.8 g, 42% solid, 1100 g/mol equivalent weight, Bayer Material Science), de-ionized (DI) water, and Desmodur® N3600 (4.17 g, 100% solid, 182 g/mol equivalent weight, Bayer Material Science) as outlined in Table 1. The NCO/OH ratio considering only the polyisocyanate and polyol was constant at 2:1. The NCO/OH ratio considering polyisocyanate, polyol and nano-talc varied as listed in Table 1. The mixtures were mixed by sonication for 1 minute with ice bath cooling to form stable dispersions. The dispersions were coated on PET film with an 8 mil gap blade and cured at RT. The haze of the film was measured using a Perkin-Elmer Lambda 900 spectrophotometer with a 150 mm Lab Sphere accessory with scanning over 300 to 800 nm using ASTM method D 1003. The films had a final thickness of about 2.8+/−0.4 mil. Pencil hardness was determined using ASTM 3363 method.

TABLE 1
List formulations using a constant amount of hydroxy-terminated
polyurethane and polyisocyanate of Example 5.

| | Nano-talc | Nano-talc | | | | |
|---|---|---|---|---|---|---|
| Ex. | loading, | Slurry, | DI water | | Haze^{c} | Pencil |
| No. | (%) | (g) | (g) | NCO/OH | (%) | Hardness |
| 1a | 0 | 0 | 13.7 | 2 | 4.59 | 2H |
| B | 2 | 2.4 | 11.6 | 1.8 | 4.79 | H |
| C | 5 | 6.3 | 8.3 | 1.5 | 5.16 | 2H |
| D | 10 | 13.2 | 2.3 | 1.2 | 5.83 | H |
| e | 20 | 29.8 | 0 | 0.8 | 7.94 | 6H |
| f | 30 | 51 | 0 | 0.6 | 20.2 | HB |
| g | 40 | 79.3 | 0 | 0.4 | 26.7 | HB |

^{c}ASTM method D 1003, procedure B used. A blank PET substrate exhibited 2.97% Haze.

### EXAMPLE 6 (COMPARATIVE)

UltraTalc®609 (99.5% solid) was used instead of nano-talc aqueous slurry in a repeat of Example 5. The formulations and results are listed in Table 2.

TABLE 2
List formulations using a constant amount of hydroxy-terminated
polyurethane and polyisocyanate of Example 6

| | | Ultra- | DI | | | |
|---|---|---|---|---|---|---|
| Ex. No. | Ultra-talc ® | talc ® | water | NCO/ | Haze | Pencil |
| comparative | loading, (%) | (g) | (g) | OH | (%) | hardness |
| 2a | 0 | 0 | 13.7 | 2 | 4.59 | 2H |
| b | 2 | 0.34 | 13.7 | 2 | 5.63 | H |
| c | 5 | 0.88 | 13.7 | 2 | 13.2 | HB |
| d | 10 | 1.85 | 13.7 | 2 | 22.7 | HB |
| e | 20 | 4.17 | 25.6 | 2 | 38.6 | HB |
| f | 30 | 7.14 | 43.9 | 2 | 48 | HB |
| g | 40 | 11.1 | 68.2 | 2 | 81 | HB |

### EXAMPLE 7

A series of loadings of nano-talc aqueous slurry (14% solid, Preparation 1), were prepared in a similar manner to Example 1 using a constant amount of Desmodur® N3600 (4.17 g, 100% solid, 182 g/mol equivalent weight) and varying the amount of Bayhydrol XP 7100E polyurethane polyol (42 wt %). Films were prepared as outlined in Table 3.

TABLE 3
List formulations using a constant amount of polyisocyanate

| | Nano-talc | Nano-talc | DI | XP7100E | | | | |
|---|---|---|---|---|---|---|---|---|
| Ex. | loading, | Slurry, | water | Polyol | NCO/OH | NCO/OH | Haze. | Pencil |
| No. | (%) | (g) | (g) | (g) | ratio^{a} | ratio^{b} | (%) | hardness |
| 3a | 0 | 0 | 13.7 | 29.8 | 2 | 2 | 4.59 | 2H |
| b | 10 | 8.8 | 4.5 | 16.6 | 3.6 | 2 | 6.36 | 2H |
| c | 20 | 14.0 | 0 | 8.8 | 6.8 | 2 | 9.70 | 2H |
| d | 30 | 17.4 | 0 | 3.6 | 16.6 | 2 | 78 | 2H |
| e | 40 | 19.8 | 0 | 0 | — | 2 | 59 | HB |

^{a}Hydroxy groups from polyurethane polyol taken into account (equiv wt 1100 g/mol).
^{b}Hydroxy groups from polyurethane polyol and nano-talc (equiv wt 242 g/mol) taken into account.

What is claimed is:

1. A polymer composite composition comprising the cured reaction product of: (A) a nano-talc component having a plurality of nano-talc particles characterized by a specific surface area of greater than about 70 m²/g, and hydroxy groups with corresponding hydroxy equivalent weight of about 210 to about 560; and, (B) a polymer, polymer precursor, or mixture thereof.

2. A polymer composite composition of claim 1 wherein said polymer, polymer precursor, or mixture thereof, is capable of covalent bonding with said hydroxy groups.

3. A polymer composite composition of claim 1 wherein said plurality of nano-talc particles are further characterized by an isoelectric point of about 2.5 to about 3.5 and said specific surface area is about 70 to about 500 m²/g.

4. A polymer composite composition of claim 1 wherein said nano-talc component comprises 1 to about 40 wt % of said polymer composite composition.

5. A polymer composite composition of claim 1 wherein (B) is a polymer, polymer precursor, or mixture thereof, capable of providing a polyester composite.

6. A polymer composite composition of claim 1 wherein (B) is a polymer or polymer precursor, or mixture thereof, capable of providing a polycarbonate composite.

7. A polymer composite composition of claim 1 wherein (B) is a polymer or polymer precursor, or mixture thereof, capable of providing a polyamide composite.

8. A polymer composite composition of claim 1 wherein (B) is a polymer or polymer precursor, or mixture thereof, capable of providing an epoxy composite.

9. A polymer composite composition of claim 1 wherein (B) is a polymer or polymer precursor, or mixture thereof, capable of providing an acrylic composite.

10. A polymer composite composition of claim 1 that is a polyurethane composite wherein (B) is a polymer or polymer precursor, or mixture thereof, capable of providing said polyurethane composite.

11. A polyurethane composite composition of claim 10 wherein (A) said nano-talc component is an aqueous nano-talc slurry; (B) is an aqueous dispersible isocyanate terminated polyurethane prepolymer; and said cured reaction product additionally comprises, optionally, (C) a polyol with a number average molecular weight of 100 to 10,000.

12. A polyurethane composite composition of claim 11 wherein said plurality of nano-talc particles are further characterized by an isoelectric point of about 2.5 to about 3.5 and said specific surface area is of about 70 to about 500 m²/g.

13. A polyurethane composite composition of clam 11 wherein said nano-talc component comprises 1 to about 40 wt % of said composition.

14. A polyurethane composite composition of claim 11 wherein said aqueous dispersible isocyanate terminated polyurethane prepolymer is selected from the group of hexamethylene diisocyanate, isophorone diisocyanate, methyl cyclohexylene diisocyanate, and prepolymers derived therefrom.

15. A polyurethane composite composition of claim 11 that is a primer coat, base coat or clear top coat for metal articles.

16. A polyurethane composite composition of claim 11 that is a primer coat, base coat or clear top coat for automobiles.

17. A curable polyurethane composite composition comprising (A) a nano-talc slurry having a plurality of nano-talc particles characterized by a specific surface area of greater than 70 m²/g, and a hydroxy equivalent weight of about 210 to about 560; (B) an aqueous dispersible isocyanate terminated polyurethane prepolymer; and, optionally, (C) a polyol with a number average molecular weight of 100 to 10,000; whereby upon coating and drying and, optionally, heating, the composition is cured to form a hardened coating.

18. A curable polyurethane composite composition of claim 17 wherein said plurality of nano-talc particles are further characterized by an isoelectric point of about 2.5 to about 3.5, and said specific surface area is about 70 to about 500 m²/g.

19. A polyurethane composite composition of clam 17 wherein said nano-talc component comprises 1 to about 40 wt % of said composition.

20. A curable polyurethane composite composition of claim 17 wherein said aqueous dispersible isocyanate terminated polyurethane prepolymer is selected from the group of hexamethylene diisocyanate, isophorone diisocyanate, methyl cyclohexylene diisocyanate, and prepolymers derived therefrom.
